(19) United States
(12) Patent Application Publication
(10) Pub. No.: US 2006/0253814 A1
(43) Pub. Date: Nov. 9, 2006

(54) Method and apparatus for fixing hold time violations in a hierarchical integrated circuit design

(76) Inventors: Howard Porter, Loveland, CO (US); Sharon Nordick, Fort Collins, CO (US); Brad Goertzen, Fort Collins, CO (US)

Correspondence Address: AVAGO TECHNOLOGIES, LTD., P.O. BOX 1920, DENVER, CO, 80201-1920, US

(21) Appl. No.: 11/120,911

(22) Filed: May 3, 2005

(51) Int. Cl. G06F 17/50

(52) U.S. Cl. 716/5

(57) ABSTRACT

A method and apparatus is presented for introducing delay compensation elements into a circuit design at the top level of the circuit design. In one embodiment, failing circuit paths are identified and grouped based on buffers that can be used to compensate for the failure in the circuit path. The buffers are organized in a library where each group of buffers has equivalent design constraints with different delay factors. As such, the buffers in a group are interchangeable and may be introduced into failing circuit paths to compensate for varying levels of delay in the circuit path.

### BACKGROUND OF THE INVENTION

### Description of the Related Art

As more circuits are implemented in integrated circuits, the design of these integrated circuits has become more complex. One important area of technology that is used to manage complex integrated circuit design is the area of simulation. A conventional integrated circuit is often simulated as part of the design process. With the number of devices in an integrated circuit growing exponentially, the simulations themselves have become very complex and time consuming. Therefore, a substantial area of technology is now directed at developing methods and techniques for reducing the complexity, time, and resource requirements of simulations.

A number of circuit parameters may be tested during a simulation. One characteristic of a circuit that is tested using simulation is the timing and delay in a integrated circuit. In conventional simulations, a large amount of effort is exerted at the beginning of a hierarchical integrated circuit design to create setup and hold constraints that insure that top-level timing is met once the circuit components are built and routed together. It is difficult to know in advance how long the delays between circuit components will be and how much delay each circuit component will contribute. Many times the design schedule is delayed due to the existence of top-level delay (i.e., hold time) failures. Since these failures are only discovered at the top level of the simulation investigation of the lower level circuit, components often have to be undertaken to discover the cause of the top-level hold time failure. Back tracking through lower levels of the simulation is tedious, time consuming, and waste a tremendous amount of resources.

A number of techniques have been attempted to address the delay problems in simulations. Delay cells can either be added at a top level of the hierarchy or they can be added at a block level after a top-level timing report is available. Extensive time budgeting work can also be done to create hold time constraints at a block level that will add delay cells ahead of time.

On designs that use top-level delay cells, multiple iterations may be necessary to fix all the hold time failures. This is due to the fact that inserting the hold buffers causes the route to change and, therefore, new failures can be introduced. In conventional systems, a new timing report would have to wait for parasitic to be generated because a delay cell was added or changed which caused a reroute of the core. Each iteration can take a large amount of time to re-route and re-extract parasitics before a timing report is available to determine if any new hold failures were introduced.

Delay cells can be placed into the lower-level blocks in the hierarchy rather than at the top level. However, each block that is affected by the top level hold failure must be re-built or undergo a manual fix. On a typical design, this may include rebuilding or fixing most of the blocks on the chip at a point in the design when the blocks should be stable. For example, once a block is placed and routed and meets timing, it is always risky to revisit the block to fix it. It may not route again, timing errors could be introduced again, etc. As a result, this approach introduces unnecessary risk to the project.

It has proved difficult to provide accurate hold time constraints at the block level because current tools either lack the capability or are run at a point when many of the physical characteristics of the chip are still unknown. Ultimately, accurate hold time constrains at the block level that have been generated using a tool that has physical knowledge should provide the best solution. However, until that tool exists, other avenues must be explored.

Thus, there is a need for a simple, cost-effective method and apparatus for simulating and assessing failures, such as hold time failures in a circuit.

### SUMMARY OF THE INVENTION

In accordance with the teachings of the present invention, a top-level hold timing analysis is performed near the end of a design cycle when all the appropriate information is available. In one embodiment, a method is presented that enables the insertion of delay cells at the top level of a circuit design so that the lower-level blocks do not need to change. As a result, if hold time failures are found later in the design, a reroute is not necessary.

Since hold time failures will be fixed at the top level, they can effectively be ignored during the construction of the lower-level hierarchy. As a result, there is minimal to no up front timing analysis for hold times.

In this invention, the route does not change after the first pass of the delay cell insertion. As a result, a timing report can be rerun without generating new parasitics. Therefore, there is a quick-turn around to get new timing results.

In accordance with the teachings of the present invention, lower-level blocks do not need to be modified. Once a top-level route is complete with the initial set of delay buffers, methods presented allow for timing adjustments without having to reroute. Lastly, fine-tuning of paths that either fail setup or fail transition time targets can be done without reroute.

A method of designing a circuit, comprises the steps of identifying failing paths in a circuit. The failing paths may be determined physically or through a simulation. In one embodiment, a failing circuit paths is a path that is failing as a result of timing issues. Each of the failing paths is correlated with a plurality of buffers, where each of the plurality of buffers is implemented with design constraints. In one embodiment, the design constraints enable the buffers to be interchanges in the circuit paths. A corrected path is then generated by inserting one buffer of the plurality of buffers in at least one of the failing paths.

A memory, comprises a library of buffers, each of the buffers in the library of buffers comprises the same design constraints. The library of buffers may be implemented with software. The library of buffers may be implemented with unique features or an interface to facilitate implementation into a simulation with failing circuit paths.

A method of designing a circuit, comprises the steps of identifying a delay in a circuit path; providing at least one first buffer from a library of buffers to compensate for the delay, the library of buffers comprising buffers each with equivalent design constraints; identifying a change in the delay in the circuit path in response to inserting at least one buffer from the library of buffers; and providing at least one second buffer from the library of buffers to compensate for the change in the delay.

A method of performing a simulation, comprises the steps of generating a first group of failing circuit paths by grouping failing circuit paths in a circuit based on an amount of delay in each group; correlating the first group of failing circuit paths with a library of buffers that compensate for a delay, the library of buffers comprising buffers each with equivalent design constraints; and inserting a first buffer from the library of buffers into each of the failing circuit paths in the first group of failing circuit paths to compensate for the delay.

### BRIEF DESCRIPTION OF THE DRAWINGS

FIG. 1 displays a flow diagram detailing a method of operating in accordance with the teachings of the present invention.

FIG. 2 displays a block diagram of a multipurpose computer used in accordance with the teachings of the present invention.

### DETAILED DESCRIPTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

A method of performing circuit design is presented. In one embodiment, simulation is used to design and troubleshoot a circuit. The simulation is performed using various simulation methods. In one embodiment, the circuit is implemented in stages. Lower-level components are implemented, which are followed by intermediate-level components and then top-level design. In accordance with the teachings of the present invention, buffers are implemented into circuit at the top level of the design to compensate for delay caused by components implemented at the lower levels. For example, components may be represented using cells, which combine to form blocks of a circuit, etc. As such, the circuit may be constructed in stages with different levels, such as a bottom level, intermediate level, and top level.

In accordance with the teachings of the present invention, a simulation of a circuit is created and a method is presented for selecting an appropriate buffer based on the magnitude of a delay in a circuit path. The appropriate buffer comes from a family of buffers that will introduce varying delays into the circuit path. Each buffer in the family of buffers is pre-configured to have equivalent design constraints (i.e., footprint, port shape, etc.). Therefore, the buffers can be easily interchanged based on the delay requirements of the circuit path. In accordance with the teachings of the present invention buffers with equivalent design constraints may be interchanged in the circuit (i.e., simulation).

Since each buffer in the family of buffers in interchangeable, if there are any timing changes in the circuit as a result of new uncertainties, a block-level change, re-routing, etc., then a replacement buffer from within the family of buffers may be used to accommodate the timing changes. The replacement buffer may introduce a smaller or larger delay into the circuit path to compensate for the timing change in the circuit path. Since each buffer in the family of buffers is configured in the same manner (i.e., same footprint, port location, etc.), the replacement buffer may be easily inserted and compensate for the timing change.

In one embodiment, a method uses timing information acquired from an initial route and creates a list of nets and a corresponding cell in the family of buffers to insert into each net. The method includes various threshold levels that correspond to a delay (i.e., hold time failure) in a circuit path. Buffers are associated with each threshold level. As the hold time failure falls within a threshold, a buffer associated with the threshold is identified for placement in the circuit path (i.e., the netlist). Choosing a large enough threshold minimizes the chances of having to reroute or switch cells.

In one embodiment, the circuit is built in stages (i.e., cells, blocks, nets, etc.). In accordance with the teachings of the present invention, hold time constraints at the block level are set such that they are non-existent or are met by default. Since the block-to-block hold times are not analyzed or fixed until the top level of the hierarchy is complete, this simplifies the process of time budgeting in the early stages of the design.

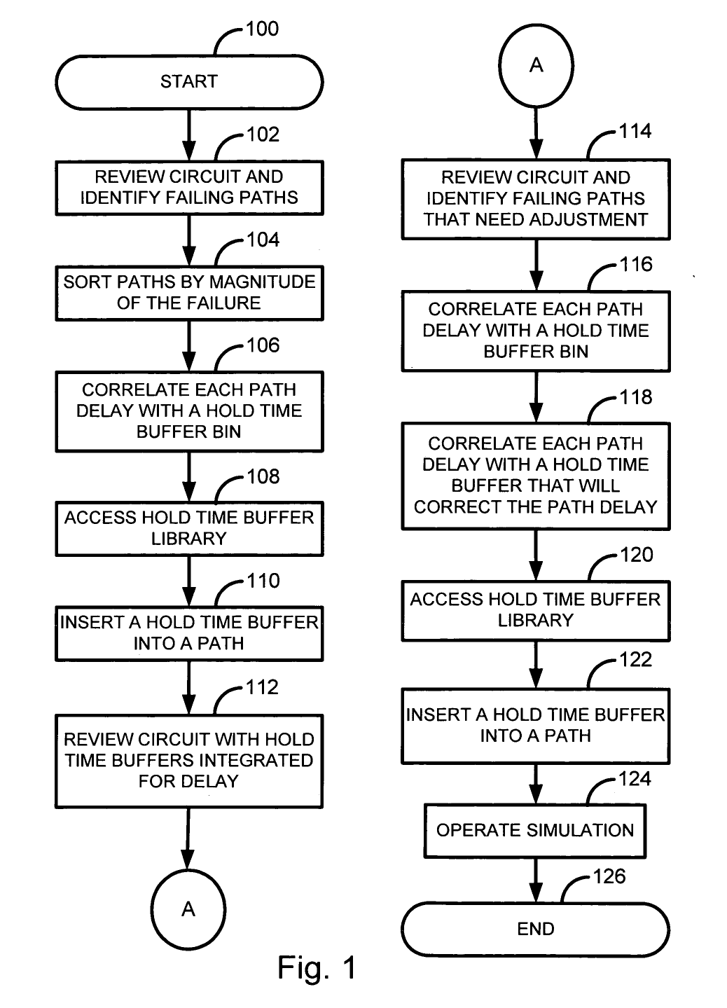

FIG. 1 displays a flow diagram detailing a method of operating in accordance with the teachings of the present invention. At step 100, the process starts. At step 102, a review is made of a circuit that is being designed, simulated, tested, etc. Each path in the circuit is analyzed to determine the delay (i.e., hold time delay) through the path. The paths that are failing due to timing issues are identified. At step 104, the failing paths are sorted based on the magnitude of the failure.

A number of hold time buffer bins are established. In one embodiment, various thresholds or bins are established each corresponding to a time delay. For example, all delays below the first threshold are assigned to bin 1; the delays that fall between the first threshold and a second threshold are assigned to bin 2, etc. At step 106, each hold time delay is correlated with a buffer bin. For example, in a 0.13μ process implementation the bins may be implemented as follows:
Bin 1—Hold failures between 0 and 100 piscoseconds (ps)
Bin 2—Hold failure between 145 and 295 ps
Bin 3—Hold failure between 294 and 400 ps
Bin 4—Hold failure between 400 and 560 ps
Bin 5—Hold failure between 560 and 655 ps.
   Therefore, using the teachings of the present invention, the delay buffer corresponding to Bin 1 has a delay of 100 ps, the delay buffer for bin 2 has a delay of 145 ps, etc. It should be appreciated that a number of different ranges may be implemented and correspond to a number of different bins.

In accordance with the teachings of the present invention, the hold time buffer bin corresponds to a family of buffers. In one embodiment, the family of buffers is stored in a library, such as a computer library that stores various simulator components. Each hold time buffer within the family of buffers is designed so that the buffer has the same footprint, port layout, etc. As such, each buffer within a specific family of buffers may be interchanged without design, etc. For example, a first buffer in the family of buffers may introduce a 1× delay; the second buffer may introduce a 2× delay, etc. Depending on the amount of delay that is required in the circuit path, one of the buffers in the family of buffers may be selected.

At step 108, the hold time buffer library is accessed to select the family of buffers that correlate to the buffer bin or hold time delay. For examples, all of the paths that have a 2× delay will be placed in the same hold time buffer bin. The hold time buffer bin corresponds to a family of buffers stored in a buffer library. As such, a family of buffers with a 2× delay will be used. At step 110, a hold time (i.e., delay) buffer is inserted into each path that requires a buffer from the family of buffers. This process is repeated for each path in the circuit that has a hold time delay. At step 112, once the hold time buffers are introduced into the circuit, the overall circuit is reviewed once again for timing delays. With the introduction of the buffers into the circuits, the overall dynamics of the circuit changes and some of the paths may still have a delay or the delay may have changed to a new delay. At step 114, a review is then made of the circuit and any failing paths that need adjustment are identified.

At step 116, each path that has a delay is correlated with a hold time buffer bin. However, in this second iteration, a variety of embodiments may be presented. In one embodiment, a total delay value is calculated and the hold time buffer bin that corresponds to the total delay value is identified. In a second embodiment, an incremental delay value is calculated and the hold time buffer bin associated with the incremental delay value is identified. At step 118, a correlation is made between the path delay and the hold time buffer that will correct the path delay. In one embodiment, the hold time buffer will correct the total path delay. In a second embodiment, the hold time buffer may provide an incremental correction of the path delay and is added to the first hold time buffer (i.e., to compensate for the full delay of the circuit path). At step 120, the hold time buffer library is accessed to retrieve the appropriate hold time buffer. At step 122, the hold time buffer is inserted into the path (i.e., inserted in the appropriate location in the netlist or other design tool). At step 124, a simulation is performed and at step 126, the process ends.

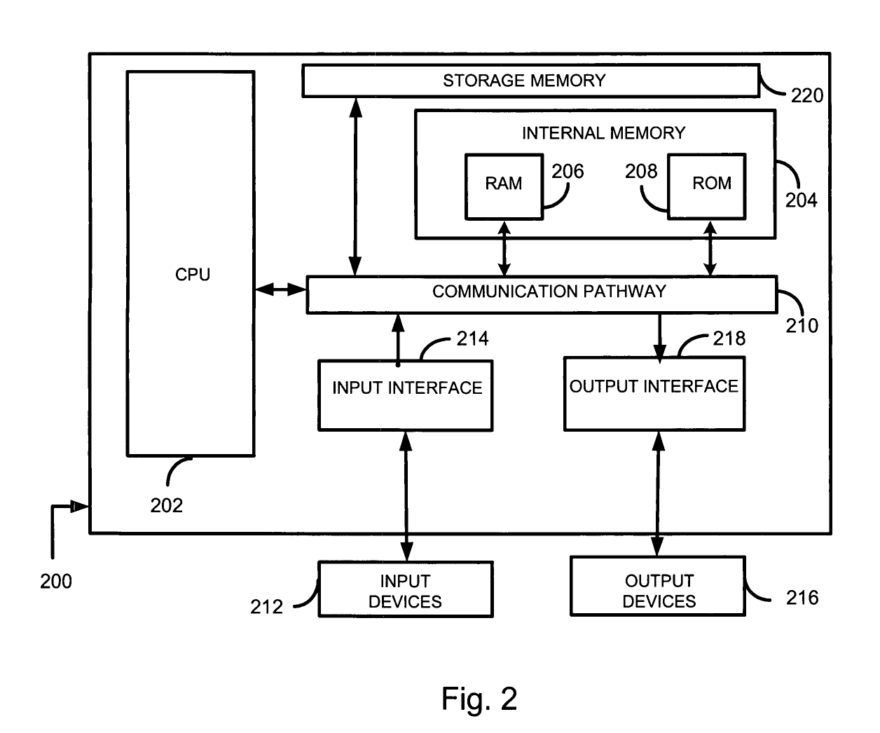

FIG. 2 displays a hardware architecture implementing the teachings of the present invention. The computer 200 may be used to implement a simulator performing the method depicted in FIG. 1. A central processing unit (CPU) 202 functions as the brain of the computer 200. Internal memory 204 is shown. The internal memory 204 includes short-term memory 206 and long-term memory 208. The short-term memory 206 may be a Random Access Memory (RAM) or a memory cache used for staging information. The long-term memory 208 may be a Read Only Memory (ROM) or an alternative form of memory used for storing information. Storage memory 220 may be any memory residing within the computer 200 other than internal memory 204. In one embodiment of the present invention, storage memory 220 is implemented with a hard drive. A library of buffers, such as the family of buffers described in association with FIG. 1, may be stored in any one of the memories (206, 208, 220). A communication pathway 210 is used to communicate information within computer 200. In addition, the communication pathway 210 may be connected to interfaces, which communicate information out of the computer 200 or receive information into the computer 200.

Input devices, such as tactile input device, joystick, keyboards, microphone, communications connections, or a mouse, are shown as 212. The input devices 212 interface with computer 200 through an input interface 214. Output devices, such as a monitor, speakers, communications connections, etc., are shown as 216. The output devices 216 communicate with computer 200 through an output interface 218.

Thus, the present invention has been described herein with reference to a particular embodiment for a particular application. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A method of designing a circuit, comprising the steps of:
identifying failing paths in a circuit;
correlating each of the failing paths to a plurality of buffers, where each of the plurality of buffers is implemented with design constraints; and
generating a corrected path by inserting one buffer of the plurality of buffers in at least one of the failing paths.

2. A method of designing a circuit as set forth in claim 1, wherein the step of identifying failing paths comprises the step of identifying a delay in each of the failing paths.

3. A method of designing a circuit as set forth in claim 1, wherein the step of correlating each of the failing paths to the plurality of buffers further comprises the step of correlating a delay in each of the failing paths to a buffer in the plurality of buffers that would correct the delay in each failing path.

4. A method of designing a circuit as set forth in claim 1, further comprising the step of identifying a delay in the corrected path and correcting the delay using one of the plurality of buffers.

5. A method of designing a circuit as set forth in claim 1, wherein the design constraints include a footprint.

6. A method of designing a circuit as set forth in claim 1, wherein the design constraints includes a port location.

7. A method of designing a circuit as set forth in claim 1, wherein the step of identifying failing paths comprises the step of identifying a delay in each of the failing paths.

8. A memory, comprising:
a library of buffers, each of the buffers in the library of buffers including the same design constraints.

9. A memory as set forth in claim 8, wherein the design constraints are footprints.

10. A memory, as set forth in claim 8, wherein the design constraints are port locations.

11. A memory as set forth in claim 8, further comprising instructions for causing a computer to measure a path delay, access the library of buffers, select at least one of the buffers to compensate for the path delay and insert said at least one buffer in a simulation.

12. A method of designing a circuit, comprising the steps of:
identifying a delay in a circuit path;
providing at least one first buffer from a library of buffers to compensate for the delay, the library of buffers comprising buffers each with equivalent design constraints;
identifying a change in the delay in the circuit path in response to inserting at least one buffer from the library of buffers; and
providing at least one second buffer from the library of buffers to compensate for the change in the delay.

13. A method of designing a circuit as set forth in claim 12, wherein the design constraints comprise a footprint.

14. A method of designing a circuit as set forth in claim 12, wherein the design constraints comprise a port location.

15. A method of designing a circuit as set forth in claim 12, wherein the first buffer and the second buffer have different delay.

16. A method of designing a circuit as set forth in claim 12, wherein the change in the delay is an incremental change in the delay.

17. A method of designing a circuit as set forth in claim 12, wherein the change in the delay represents the delay in the circuit path.

18. The method of designing a circuit as set forth in claim 12 is performed in a top level of a design process.

19. A method of designing a circuit as set forth in claim 12, wherein the circuit path is grouped with other circuit paths with equal delay and each circuit path is correlated with a bin that corresponds to the at least one first buffer.

20. A method of designing a circuit as set forth in claim 12, wherein the circuit path is grouped with other circuit paths with equal delay and each circuit path is correlated with a bin that corresponds to the at least one second buffer.

21. A method of performing a simulation, comprising the steps of:
generating a first group of failing circuit paths by grouping failing circuit paths in a circuit based on an amount of delay in each group;
correlating the first group of failing circuit paths with a library of buffers that compensate for a delay, the library of buffers comprising buffers each with equivalent design constraints; and
inserting a first buffer from the library of buffers into each of the failing circuit paths in the first group of failing circuit paths to compensate for the delay.

22. A method of performing a simulation as set forth in claim 21, further comprising the steps of generating a second group of failing circuit paths by grouping failing circuit paths from the first group of failing circuit paths, and inserting a second buffer from the library of buffers into each of the failing circuit paths in the second group of failing circuit paths to compensate for a delay.
